(19) United States
(12) Patent Application Publication
(10) Pub. No.: US 2007/0210286 A1
(43) Pub. Date: Sep. 13, 2007

(54) Transparent plastic articles having controlled solar energy transmittance properties and methods of making

(75) Inventors: Carlos Guerra, Fairfield, CT (US); Kyle Halligan, Fairfield, CT (US)

Correspondence Address: JOHN S. BEULICK;C/O ARMSTRONG TEASDALE, LLP, ONE METROPOLITAN SQUARE, SUITE 2600, ST LOUIS, MO, 63102-2740, US

(73) Assignee: Spartech Corporation

(21) Appl. No.: 11/370,613

(22) Filed: Mar. 8, 2006

(51) Int. Cl. F21V 9/00; G02B 5/00; G02C 7/10

(52) U.S. Cl. 252/582

(57) ABSTRACT

A method of making a transparent plastic article having controlled solar energy transmittance properties includes, in one embodiment, providing a fluid thermoplastic material, and adding from about 0.003 percent by weight to about 0.1 percent by weight of a perylene based dye to form a mixture. The perylene based die being capable of preferentially absorbing energy having wavelengths of about 700 nanometers (nm) to about 1100 nm. The method further includes cooling the mixture to form a transparent thermoplastic article with controlled solar energy transmittance properties.

### BACKGROUND OF THE INVENTION

This invention relates generally to transparent plastic articles, and more particularly, to transparent plastic articles having a reduced solar energy transmittance over known transparent plastic articles.

Transparent plastics are sometimes used for windows in buildings, vehicles, airplanes, telephone booths, etc. Solar energy easily passes through transparent plastics and can raise the temperature of the area inside, for example, an airplane, and particularly the cockpit of an airplane.

There are a number of applications where plastics are used to allow the passage of useful visible light while at the same time controlling the amount of solar energy (heat) transmitted through the plastic. It is known to attempt to control the transmission of solar energy using thin films and coatings containing dyes, pigments carbon black, metal oxides, for example, FeOₓ, CoOₓ, CrOₓ, and TiOₓ, and metals, for example Ag, Au, Cu, Ni, and Al. However, these known films reduce both infrared light (heat) and visible light. However, when these films or coatings are applied to transparent plastic flat sheets, the resulting product usually cannot be thermoformed. Also, the coatings and films are difficult and expensive to apply to a formed shape.

### BRIEF DESCRIPTION OF THE INVENTION

In one aspect, a method of making a transparent plastic article having controlled solar energy transmittance properties is provided. The method includes providing a liquid thermoplastic material, and adding from about 0.003 percent by weight to about 0.1 percent by weight of a perylene based dye to form a mixture. The perylene based die being capable of preferentially absorbing energy between the wavelengths of about 700 nanometers (nm) to about 1100 nm. The method further includes cooling the mixture to form a transparent thermoplastic article with controlled solar energy transmittance properties.

In another aspect, a transparent plastic article having a reduced energy transmittance over known transparent plastic articles is provided. The transparent plastic article is formed from components including a thermoplastic material and from about 0.003 percent by weight to about 0.1 percent by weight of a perylene based dye. The perylene based dye being capable of preferentially absorbing energy between the wavelengths of about 700 nm to about 1100 nm.

### BRIEF DESCRIPTION OF THE DRAWINGS

FIG. 1 is a graph that illustrates the spectral transmission properties of test samples A and C.

### DETAILED DESCRIPTION OF THE INVENTION

A transparent plastic article having controlled solar energy transmission properties and methods of making the article is described below in detail. The transparent plastic article is formed from a thermoplastic resin and about 0.003 to about 0.1 weight percent of a perylene based dye having the ability to preferentially absorb solar energy between the wavelengths of about 700 mm to about 1100 nm. The infrared (IR) absorbing dye reduces the ratio of IR light vs. visible light transmitted through the plastic article. Because less IR light is transmitted for a given amount of visible light, less heat is transmitted through the transparent plastic article. This phenomenon is desirable in applications such as automobiles and aircraft where the interior space is small relative to the size of the windows and/or windshields.

In an exemplary embodiment, a transparent plastic article is formed from a thermoplastic material, for example, a thermoplastic resin or a monomer that is subsequently polymerized to form a solid thermoplastic resin, and about 0.003 to about 0.1 weight percent of a perylene based dye having the ability to preferentially absorb solar energy between the wavelengths of about 700 nm to about 1100 nm. The perylene based dye is dissolved and/or dispersed in the fluid form of the thermoplastic resin to form a mixture. In one embodiment, solid thermoplastic particles and/or pellets of the resin are melted by heating to produce a fluid thermoplastic resin before dissolving and/or dispersing the perylene based dye in the resin. The mixture is then cast into a mold, cooled, and removed from the mold to form the transparent thermoplastic article. In another embodiment, the mixture is extruded through a die to form a continuous web which is then cooled to form a continuous sheet of the thermoplastic article, which can then be cut to a desired predetermined size. In one embodiment, the transparent thermoplastic article permits at least about 75 percent transmission of visible light, in another embodiment, at least about 50 percent transmission of visible light, and in another embodiment, at least about 15 percent transmission of visible light while absorbing solar energy having wavelengths of about 700 nm and about 1100 nm.

It should be understood that as used herein, “formed from” denotes open, e.g., “comprising”, claim language. As such, it is intended that a composition “formed from” a list of components be a composition comprising at least these recited components, and can further comprise other, nonrecited components, during the composition's formation, for example UV absorbers, surfactants, pigments, and the like.

The perylene based dye is incorporated into the thermoplastic resin by any suitable method. Some non limiting examples include by using a mixing tank and a simple stirring apparatus, by using high energy dispersion equipment such as Cowles blades, mills, attritters, and the like, and by using an extruder. In one embodiment, the resin is heated to a temperature sufficient to melt the thermoplastic resin forming a fluid before incorporating the perylene based dye. In another embodiment, the perylene based die is a solid material and is mixed with solid particles and/or pellets of the thermoplastic resin prior to heating and melting the resin. The perylene chemical structure in the perylene based dyes used in the present invention can be modified by the addition of other chemical groups which can modify the maximum absorption region in the infrared spectrum. Perylene based dyes are commercially available from, for example, BASF Corporation under the Lumogen® IR trademark.

Suitable thermoplastic resins that can be used in embodiments of the present invention include, but are not limited to, acrylic resins, polycarbonate resins, styrene resins, and mixtures thereof. In one embodiment, the acrylic resin is formed by polymerizing an alkyl (meth)acrylate monomer. The acrylic resins can be copolymers of one or more alkyl esters of acrylic acid or methacrylic acid having from 1 to 20 carbon atoms in the alkyl group optionally together with one or more other polymerizable ethylenically unsaturated monomers. Suitable alkyl esters of acrylic acid or methacrylic acid include methyl(meth)acrylate, isobutyl(meth)acrylate, alpha-methyl styrene dimer, ethyl(meth)acrylate, n-butyl(meth)acrylate, and 2-ethylhexyl (meth)acrylate. Suitable other copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate. It should be noted that the term “(meth)acrylate” refers to both methacrylate and acrylate.

The invention will be further described by reference to the following examples which are presented for the purpose of illustration only and are not intended to limit the scope of the invention. Unless otherwise indicated, all amounts are listed as parts by weight.

Different colorants were compared to perylene based dyes by incorporating them into thermoplastic acrylic sheets. Samples A and B included both phthalo green pigment and carbon black pigment, and Samples C-F included different concentrations of a perylene based dye, Lumogen® IR788. Table I below shows the compositions of Samples A-F. The acrylic sheets were 0.125 inch thick and were produced by the cell casting method. The optical performance of Samples A-F was evaluated by two different methods. One method used theoretical calculations using the Lawrence Berkeley National Laboratory (LBNL) Optics Software, version 5. The other method utilized a solar energy collector. The device consists of two separate small enclosures with an opening in each. The thermoplastic samples tested were positioned to cover the openings. Inside each enclosure was a thermocouple wire connected to an instrument to measure the temperature. The device was placed outdoors with the openings facing the sun.

TABLE I

| Ingredients | A | B | C | D | E | F |
|---|---|---|---|---|---|---|
| Methyl | 99 | 99 | 99 | 99 | 99 | 99 |
| Methacrylate | | | | | | |
| Monomer | | | | | | |
| Azo-Type Free | 0.09 | 0.09 | 0.09 | 0.09 | 0.09 | 0.09 |
| Radical | | | | | | |
| Initiator | | | | | | |
| Chain Regulator | 0.02 | 0.02 | 0.02 | 0.02 | 0.02 | 0.02 |
| UV Absorber | 0.1 | 0.1 | 0.1 | 0.1 | 0.1 | 0.1 |
| Phthalo Green | 0.003 | 0.008 | 0 | 0 | 0 | 0 |
| Pigment | | | | | | |
| Carbon Black | 0.005 | 0.018 | 0 | 0 | 0 | 0 |
| Pigment | | | | | | |
| Perylene-Based | 0 | 0 | 0.007 | 0.028 | .003 | 0.1 |
| IR Dye* | | | | | | |

*LUMOGEN IR 788 commercially available from BASF Corporation.

Sample Preparation: The ingredients for each of Samples A-D were dissolved or dispersed in the acrylic monomer. The mixture was degassed and then poured inside a casting mold. The mold consisted of two glass plates separated by a soft gasket material and the assembly was kept together by spring clamps. The molds containing the test mixtures were placed in air-circulating ovens to polymerize. The casting cycles are approximately 4 to 12 hours at about 60° C. followed by 1 to 3 hours at temperatures of about 100° C. or higher. A slow cooling period followed. At the end of the casting process, the clamps were removed and the glass plates were separated from the resulting acrylic sheet.

Test samples were cut from Samples A-F. The test samples were evaluated using a scanning spectrophotometer to obtain the spectral light transmission properties. These values were entered in the LBNL Optics Software to calculate their visible light transmission and solar energy transmission. The test samples of Samples A and C were also tested outdoors using the solar collector device described above. Table II below shows the percent visible light and the percent solar energy transmission calculated by the LBNL Optics Software for Samples A-F. The observed temperature for Sample A in the solar collector device was 142° F. and the observed temperature for Sample C was 132° F.

TABLE II

| | A | B | C | D | E | F |
|---|---|---|---|---|---|---|
| % Visible Light Transmission | 77 | 52 | 77 | 51 | 85 | 18 |
| % Solar Energy Transmission | 75 | 53 | 58 | 39 | 68 | 28 |

Also, Sample C was compared to commercially available acrylic sheets of several commercially available transparent colors having the same visible light transmission as Sample C. A clear acrylic sheet was also included for reference purposes. Table II below shows the results of this comparison.

TABLE III

| | % Visible | Theoretical % | |
|---|---|---|---|
| | Light | Solar Energy | Peak |
| | Transmission | Transmission* | Temperature** |
| Clear Acrylic | 92% | 85% | 63.6 C. (146.5 F.) |
| Light Blue #1 | 78% | 78% | 61.3 C. (142.3 F.) |
| Light Gray | 76% | 74% | 59.4 C. (138.9 F.) |
| Light Blue #2 | 77% | 79% | 60.7 C. (141.3 F.) |
| Light Green | 77% | 75% | 60.9 C. (141.6 F.) |
| Sample C | 77% | 58% | 55.5 C. (131.9 F.) |

*Solar Energy calculated using Lawrence Berkeley National Laboratory Optics Software, version 5
**Peak Temperature calculated relative to standard Ambient Temperature of 21 C. (69.8 F.)

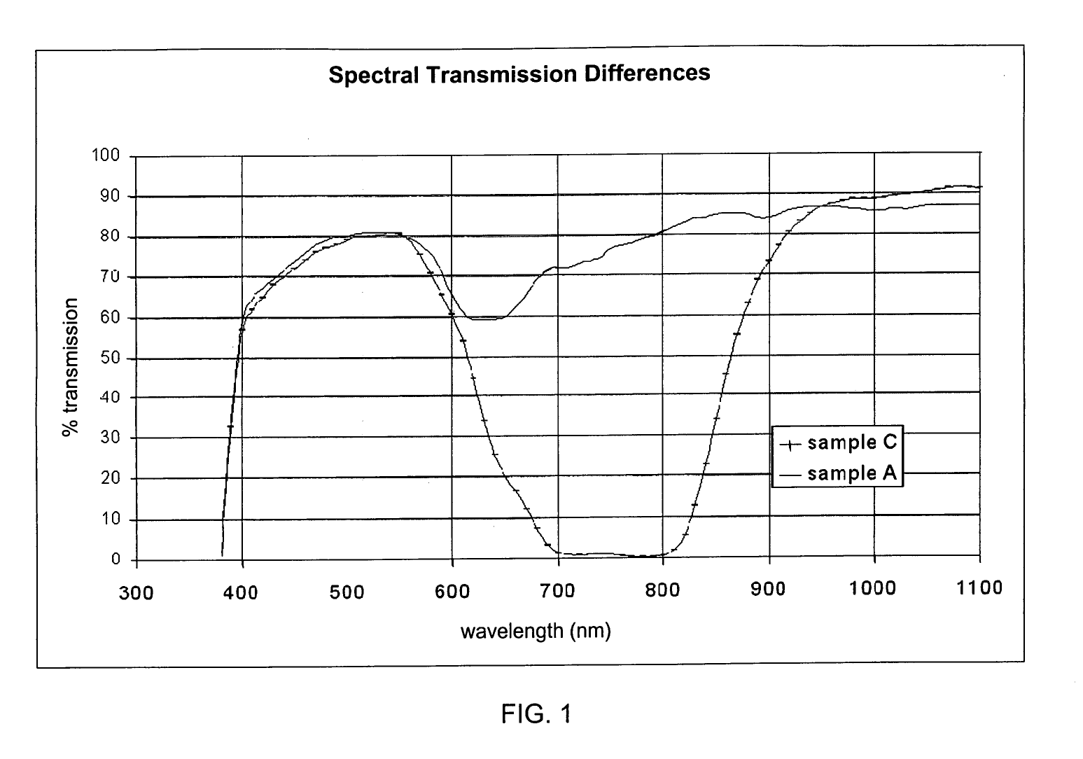

The above described evaluations show that thermoplastic articles that include a perylene based dye transmit less solar energy than known, commonly used, colored pigments and dyes. Also, as shown in Table III, colored transparent acrylic sheets having a visible light transmission similar to Sample C transmits more solar energy than the acrylic sheet of Sample C that contains a perylene based dye. FIG. 1 illustrates the spectral transmission properties of Samples A and C. It can be seen that while the transmission properties in the visible region (approximately 550 nm) are very similar, Sample C transmits much less in the 700 nm to 800 nm range (the “near-infrared”) than Sample A. The area in the graph shows the difference and it explains the reduction in solar heat.

While the invention has been described in terms of various specific embodiments, those skilled in the art will recognize that the invention can be practiced with modification within the spirit and scope of the claims.

What is claimed is:

1. Method of making a transparent plastic article with controlled solar energy transmittance properties, said method comprising:
providing a fluid thermoplastic material;
adding from about 0.003 percent by weight to about 0.1 percent by weight of a perylene based dye to form a mixture, the perylene based die capable of preferentially absorbing energy having wavelengths of about 700 nm to about 1100 nm; and
cooling the mixture to form a transparent thermoplastic article with controlled solar energy transmittance properties.

2. A method in accordance with claim 1 comprising adding from about 0.005 percent by weight to about 0.05 percent by weight of a perylene based dye to form a mixture, the perylene based die capable of preferentially absorbing energy having wavelengths of about 700 nm to about 1100 nm.

3. A method in accordance with claim 1 comprising adding from about 0.006 percent by weight to about 0.03 percent by weight of a perylene based dye to form a mixture, the perylene based die capable of preferentially absorbing energy having wavelengths of about 700 nm to about 1100 nm.

4. A method in accordance with claim 1 wherein providing a thermoplastic material comprises providing a thermoplastic resin selected from acrylic resins, polycarbonate resins, styrene resins, and mixtures thereof.

5. A method in accordance with claim 4 wherein adding from about 0.005 percent by weight to about 0.05 percent by weight of a perylene based dye comprises at least one of dispersing the dye in the thermoplastic resin and dissolving the dye in the thermoplastic resin.

6. A method in accordance with claim 1 wherein providing a thermoplastic material comprises providing an alkyl (meth)acrylate monomer and wherein adding from about 0.005 percent by weight to about 0.05 percent by weight of a perylene based dye comprises dissolving the dye in the monomer.

7. A method in accordance with claim 6 further comprising polymerizing the monomer by heating the monomer and dye solution.

8. A method in accordance with claim 1 further comprising:
heating the thermoplastic material and dye mixture;
directing the thermoplastic material and dye mixture into a mold;
cooling the mixture to form the transparent thermoplastic article; and
removing the transparent thermoplastic article from the mold.

9. A method in accordance with claim 1 further comprising:
directing the thermoplastic material and dye mixture through an extrusion die to form a continuous web of transparent thermoplastic material; and
cooling the continuous web of transparent thermoplastic material to form a transparent thermoplastic sheet.

10. A transparent plastic article having a controlled solar energy transmittance properties, said transparent plastic article formed from components comprising:
a thermoplastic material; and
from about 0.003 percent by weight to about 0.1 percent by weight of a perylene based dye, the perylene based dye capable of preferentially absorbing energy having wavelengths of about 700 nm to about 1100 mm.

11. A transparent plastic article in accordance with claim 1 comprising from about 0.005 percent by weight to about 0.05 percent by weight of a perylene based dye, the perylene based dye capable of preferentially absorbing energy having wavelengths of about 700 nm to about 1100 nm.

12. A transparent plastic article in accordance with claim 1 comprising from about 0.006 percent by weight to about 0.03 percent by weight of a perylene based dye, the perylene based dye capable of preferentially absorbing energy having wavelengths of about 700 nm to about 1100 nm.

13. A transparent plastic article in accordance with claim 10 wherein said thermoplastic material comprises a thermoplastic resin selected from acrylic resins, polycarbonate resins, styrene resins, and mixtures thereof.

14. A transparent plastic article in accordance with claim 13 wherein said perylene based dye is dissolved or dispersed in said thermoplastic resin.

15. A transparent plastic article in accordance with claim 13 wherein said transparent plastic article is formed from said acrylic resin and said perlyne based dye, said acrylic resin comprising an alkyl (meth)acrylate monomer that has been polymerized after said perylene based dye has been dissolved in said monomer.

16. A transparent plastic article in accordance with claim 10 wherein said transparent plastic article is formed in a mold.

17. A transparent plastic article in accordance with claim 10 wherein said transparent plastic article is formed as a continuous transparent plastic sheet.

18. A transparent plastic article in accordance with claim 10 wherein said transparent plastic article permits at least about 75 percent transmission of visible light.

19. A transparent plastic article in accordance with claim 10 wherein said transparent plastic article permits at least about 50 percent transmission of visible light.

20. A transparent plastic article in accordance with claim 10 wherein said transparent plastic article permits at least about 15 percent transmission of visible light.
